(19) United States
(12) Patent Application Publication
(10) Pub. No.: US 2009/0083146 A1
(43) Pub. Date: Mar. 26, 2009

(54) Methods for protecting advertisers against cheats in an EV system for paying and qualifying audiences

(76) Inventor: Michael T. Rossides, Scottsdale, AZ (US)

Correspondence Address: Michael Rossides, 11167 E. Mirasol Circle, Scottsdale, AZ, 85255, US

(21) Appl. No.: 11/903,231

(22) Filed: Sep. 20, 2007

(51) Int. Cl. G06Q 30/00

(52) U.S. Cl. 705/14

(57) ABSTRACT

An expected value system for paying and qualifying audiences (EVSPQ) is an online database system for paying users for their attention provided that they meet a specified condition or conditions. In this system, advertisers post EV payment offers.

Using the system, a recipient of EV payment accepts a payment offer; the system stores this acceptance in a recipient's acceptance history, and triggers the execution of an EV payment bet corresponding to the terms of the payment offer. If the recipient wins this payment bet, the EVSPQ enables the recipient to state whether he has met the conditions of the payment offer, and therefore, is owed the payment bet payoff.

In an EVSPQ for paying “realbuyers” (EVSPQ-RB) a qualifying condition of payment is that a user makes a purchase after being exposed to a message.

The inventive method is a module to be added to an EVSPQ-RB that operates to deter cheating by recipients.

The method comprises the following steps: (1) when a recipient claims a payoff from an EV payment bet, the EVSPQ-RB asks the recipient whether he made the required purchase from a seller who has posted an offer in the EVSPQ-RB or from a seller who has not posted an offer in the EVSPQ-RB, (2) the EVSQP-RB stores the recipient's response in the recipients user history, (3) the EVSPQ-RB measures the ratio of purchases from sellers in the EVSPQ and purchases from sellers without, (4) the EVSPQ-RB enables sellers to shield offers from users whose ratio, or equivalently useful statistic, is below a threshold.

### CROSS-REFERENCES TO RELATED APPLICATIONS

This specification was preceded by, and claims benefit of, provisional patent application 60/565,538, entitled Methods for Protecting Advertisers Against Cheats in an EV System for Paying and Qualifying Audiences, filed Apr. 26, 2004.

This specification was preceded by disclosure documents 481,613, filed Oct. 23, 2000, entitled Various, and 531,657, filed May 19, 2003, entitled Expected Value Methods and Systems for Paying and Qualifying—Additional Matter.

This specification refers to U.S. patent application Ser. No. 10/042,975, Expected Value Methods and Systems for Paying and Qualifying, filed on Jan. 7, 2002, and incorporated by reference.

This application incorporates by reference U.S. patent application Ser. No. 10/811,643, Methods for Transferring Payment in EV Payment and Verification Systems, filed on Mar. 29, 2004.

This application also incorporates by reference, U.S. patent application Ser. No. 10/700,836, filed on Nov. 3, 2003, entitled Method and System for Paying Decision Makers for Attention.

### STATEMENT REGARDING FEDERALLY SPONSORED RESEARCH

Not applicable.

### BACKGROUND OF THE INVENTION

This invention relates to methods for paying qualified audiences for their attention.

U.S. patent application Ser. Nos. 09/536,727 and 10/042,975, Expected Value Methods and Systems for Paying and Qualifying, also by the author, disclosed a method and system for paying users for their attention, and for qualifying (verifying) that those users met conditions set forth by paying advertisers.

U.S. patent application Ser. No. 10/042,975 further disclosed a system for paying people—the application called them realbuyers—who bought a specified product or service at some point after being exposed to an advertising (sales) message.

This application discloses several methods for deterring cheating by users of the system of application Ser. No. 10/042,975, especially cheating where the embodiment of the system is for paying realbuyers. Thus, the inventive methods are improvements on the method and system of application Ser. No. 10/042,975.

The author is not aware of other disclosures of these improvement methods (further, the author does not know of any disclosure that describes any method or system equivalent to the disclosure in U.S. patent application Ser. No. 10/042,975).

### BRIEF SUMMARY OF THE INVENTION

The object of the invention is to deter cheating by users of a system for paying qualified people for their attention, especially people whose key qualification is that they buy a specified product or engage in any specified economic transaction after exposure to a message.

An expected value system for paying and qualifying audiences (EVSPQ) is an online database system for paying users for their attention provided that they meet a specified condition or conditions. In this system, advertisers post EV payment offers. Using the system, a recipient of EV payment accepts a payment offer; the system stores this acceptance in a recipient's acceptance history, and triggers the execution of an EV payment bet corresponding to the terms of the payment offer. If the recipient wins this payment bet, the EVSPQ enables the recipient to state whether he has met the conditions of the payment offer, and therefore, is owed the payment bet payoff.

In an EVSPQ for paying “realbuyers” (EVSPQ-RB) a qualifying condition of payment is that a user makes a specified purchase after being exposed to a specified message. The inventive method is a module to be added to an EVSPQ-RB to deter cheating.

The method comprises the following steps: (1) when a recipient claims a payoff from an EV payment bet, the EVSPQ-RB asks the recipient whether he made the required purchase from a seller whose advertising message the recipient was exposed to via the EVSPQ-RB or from a seller who the recipient found through other means, (2) the EVSQP-RB stores the recipient's response in the recipient's user history, (3) the EVSPQ-RB measures the ratio of purchases from sellers whose message the recipient was exposed to via the EVSPQ-RB and purchases from sellers that the recipient found through other means, (4) the EVSPQ-RB enables sellers to shield offers from users whose ratio, or equivalently useful statistic, is below a threshold.

Additional methods are also disclosed for defending against sham transaction cheats, multiple identities cheats, and receipt cheats.

### BRIEF DESCRIPTION OF THE DRAWINGS

There are no drawings.

### DETAILED DESCRIPTION OF THE INVENTION

### Contents

How this Specification Is Written

### Where the Invention Applies

### Initial Definitions

### A. Module for Deterring the No Intention of (or Low Probability of) Buying Cheat

### B. Modules for Deterring Other Cheats

B1. Sham Purchases Cheat
B2. Multiple Use of Receipt Cheat
B3. Multiple Identities Cheat

### C. Module for Detecting and Rewarding High Probability Prospects

How this Specification is Written

This specification is organized as descriptions of modules (processes) for operating an online computer database. The modules are high-level descriptions that we use for clarity. The modules themselves can be decomposed into smaller sets of steps, and rearranged, as is apparent to those skilled in technical writing or programming.

The modules may be performed on a single, “central” database system, or they may be performed by “separate” computing database entities that communicate with each other.

The goal of this specification is to disclose the novel aspects of the inventive method and system. There is no ideal way to present these aspects, and so, those skilled in technical writing or programming will see better ways to organize and present this disclosure.

Example cases are provided. Those skilled in the art will know that these examples are illustrative only and do not limit the range of applications of the present invention.

### Where the Invention Applies

U.S. patent application Ser. No. 10/042,975, Expected Value Methods and Systems for Paying and Qualifying, also by the author, disclosed a system for paying users for their attention, and for qualifying (verifying) that those users met conditions set forth by paying advertisers. U.S. patent application Ser. No. 10/042,975 further disclosed a system for paying people—the application called them realbuyers—who buy a specified product or service at some point after being exposed to a message.

We incorporate by reference all the methods taught in application Ser. No. 10/042,975 and in related, referenced applications above.

This specification discloses several methods for deterring cheating by users of the system of application Ser. No. 10/042,975, especially cheating where the embodiment of the system is for paying realbuyers. Thus, the inventive methods of this specification are improvements on the system of application Ser. No. 10/042,975.

For clarity's sake, we summarize key aspects of the invention of 10/042,975, since the inventive method disclosed here builds upon that invention. However, we do not rely on these summaries, but upon the disclosure of application Ser. No. 10/042,975.

An expected value system for paying and qualifying (EVSPQ) is an online database system for paying users for their attention provided that they meet specified conditions. In this system, advertisers post EV payment offers.

Using the system, a recipient of EV payment accepts a payment offer; the system stores this acceptance in a recipient's acceptance history, and triggers the execution of an EV payment bet corresponding to the terms of the payment offer. If the recipient wins this payment bet, the EVSPQ enables the recipient to state whether he has met the conditions of the payment offer, and therefore, is owed the payment bet payoff.

In an EVSPQ for paying “realbuyers” (EVSPQ-RB) a qualifying condition of payment is that a user makes a purchase after being exposed to a specified ad (sales) message.

### Inventive Method Applies to Non-Competitive Directory Embodiment of an EVSPQ

One embodiment of an EVSPQ is a “non-competitive” directory in which different sellers post payment-for-attention offers to prospective realbuyers. We say non-competitive in the sense that competing offers are not shown together. The purpose of the directory—which can also be called a service bureau—is to enable sellers to transact these pay-for-attention offers. Sellers will often want to cooperate with each other to make sure that recipients of payment are not gaming those offers.

### Pay-for-Placement Embodiment of an EVSPQ

One embodiment of an EVSPQ is a “competitive” directory in which different sellers post payment-for-attention offers to prospective realbuyers, such that offers are presented competitively, under search criteria. One sub-embodiment of this kind of competitive directory is a pay-for-placement directory in which offers are ranked under a given set of search criteria according to how much the sellers offer to pay realbuyers. Thus, for instance, two offers under the search criteria barbershop+zip code 85254, might offer pay a realbuyer EV $2 and EV $1, respectively, to call the advertisers. In this case, the offer for EV $2 would be presented above the offer for EV $1.

### Inventive Methods Apply to Non-Competitive and Competitive Directories

The inventive methods of this specification operate in competitive and non-competitive EVSPQ directories. We will use a pay-for-placement directory to illustrate (this illustration is not meant to limit the scope of the invention).

### Initial Definitions

Note: The definitions below are meant to be consistent with those in application Ser. No. 10/042,975, although there are minor differences in terms.

EVSPQ and EVSPQ-RB—see above.

Two-Bet EV Payment Process. An EV payment bet process, also called a parlay process, in which the payoff from a first bet is the expected value of the second bet, for a recipient of payment. For more detail, see U.S. patent application Ser. No. 10/811,643, referenced above.

Seller. A person or organization (or agent) that makes an EV payment for attention offer in and EVSPQ or EVSPQ-RB. Seller is a broad, economics term that encompasses any person or entity selling/leasing/loaning a product or service of any kind, or soliciting for money or commodities.

Advertiser. In this specification, advertiser means the same thing as seller.

Sales Message. Any kind of message, delivered in any way, including interactive messaging, including conversation advertising with a person.

Advertisement (Ad). Advertisement will mean the same thing as a sales message.

Recipient. A user who has accepted an EV payment-for-attention offer. The user has thus received a form of provisional payment. Sometimes represented by the name Reece.

Acceptance. An action by a recipient to accept a payment offer made by a seller. Another term for an acceptance is a claim.

Acceptance Record. The record that the EVSPQ stores for all the information involved in an acceptance from the point of acceptance through possible payment of a payoff. Another term for acceptance record is claim record.

Payoff claim. In order for a user to collect the payoff from an EV payment bet, he must submit a claim that he has met the conditions of the payment offer. A payoff claim can include evidence that he has met the conditions of the payment offer.

Recipient's Acceptance History. A compilation file kept by the EVSPQ of all of a recipient's acceptance records. Two other terms for acceptance history are a claim history and a user history. An acceptance history will include records of payoff claims made by a recipient. Or, an acceptance history and a payoff claim history will be separate files within a larger user history. (Various storage schemes are possible for acceptance and payoff claim information, as is well known to those skilled in the art.)

Sale. Any kind of sale or purchase (any expenditure of money for some product). Sale is a broad, economics term encompassing one-time purchases, leases, loans, donations, and so forth—virtually any kind of economic transaction.

Buyer. A broad, economics term that encompasses any person or entity (org) that buys/rents/borrow/donates—that is on one end of an economic transaction.

Realbuyer (RB). A recipient who buys a product in accordance with a realbuyer payment offer, as defined in application Ser. No. 10/042,975, and related applications by the same author.

Receipt. Any proof-of-transaction, as required by a realbuyer payment offer.

Prospect. A person or organization that might become a buyer.

Product. A broad economics term that encompasses any product or service including loans and donations.

### A. Module for Deterring the No Intention of (or Low Probability of) Buying Cheat

### Deterring “Free-Rider” Cheaters

Sellers make payment offers to realbuyers via the EVSPQ-RB. A seller's payment offer depends on the conversion rate he achieves for his advertising. The higher the conversion rate the higher the payment that can be offered.

Cheaters, users who have no intention of buying from an EVSPQ-RB listed seller whose ad they are exposed to, reduce the conversion rate, threatening the efficiency of the system. We can call this kind of cheater a free-rider.

A free-rider is also a person who has an abnormally low probability of buying from a seller whose ad he has been exposed to via the EVSPQ-RB. That is, a free-rider will have a lower actual ratio of buying from an EVSPQ-RB seller than the average user.

In a free-rider cheat the user knows the seller he is going to buy from outside the EVSPQ-RB, and decides to accept offers from sellers in the EVSPQ-RB just to collect EV payments. For example, a user may have decided to buy a tennis racket from his local shop and then goes to EVSPQ-RB to clicks on links of (accepts offers of) tennis shops just for the collect payments.

It is impossible to stop this cheat completely as even the most honest user will, from time to time, take advantage of the system by accepting more offers, e.g., by clicking on more links, than he is really interested in. The goal of a deterrence module, then, is to stop heavy cheaters and even deter casual cheaters from “taking a few extra EV payments.”

### Prefatory Note: Use of a Two-Bet EV Payment Process

We will assume that EVSPQ-RB employs a two-bet payment process (although this process is not essential). A two-bet process enables the system to gather information more quickly to catch cheaters through outlier tests, before the cheaters can collect a second-bet payoff.

U.S. patent application Ser. No. 10/811,643, referenced above, describes two-bet payment processes and the collection of data in such processes. The key data to collect after a first-bet win is whether or not the winning user made a purchase, and if so, whether or not the user made the purchase from an EVSPQ-RB seller whose ad the user was exposed to.

A two-bet process makes it much easier to catch outliers, because a purchase history can be examined before too many payoffs have been awarded.

For example, assuming that there is a 2-bet process in which the recipient's chance of winning is 1 in 10 in the first bet and 1 in 10 in the second bet. For simplicity, let us also assume that the user has made a purchase each time he has accepted a payment offer. Then, there will be a 10-purchase history on average before a final payoff is made.

### Using “Outlier” Tests to Distinguish Between Cheaters and Non-Cheaters

The invention will provide a module for performing outlier tests on a user's acceptance history to detect whether a user's acceptance behavior indicates that he is a cheater of not.

By outlier we have in mind a broad definition of “out of the ordinary” or outside the norms that system operators have established, not a strict statistical definition.

(Note that these outlier tests can also use demographic information that the system stores in a user ID file when the user registers for the system.)

A norm can be generated automatically by pre-determined statistical test(s) performed on a large set of acceptances by different users. Many statistical methods of determining norms exist. But, as noted, a system operator can simply set a norm as a rule of the system. For example, a system operator may decide/define that a “normal” user of EVSPQ-RB must purchase from a seller in EVSPQ-RB at least 15% of the time that the user makes a purchase that he has searched about in the EVSPQ-RB.

Accordingly, the invention provides a method for executing the following steps:
applying an outlier test to a user's acceptance history to measure whether the user is a free-rider (cheater),
if the test indicates that the user's behavior is outside a norm set by a system formula, or a norm set by a system operator, then putting a flag in the use's acceptance history indicating that the user is outside the norm, and is a free-rider,
measuring how far outside the norm the user is,
putting that measurement in the user's acceptance history.

The inventive method also can provide steps for enabling a system operator to penalize a user who has an outlier/free-rider flag in his user history or who has an outlier/free-rider measurement above a threshold. For example, if a user is found to be a free-rider cheater, according to an outlier test, then the system can automatically ban the user from accepting EV payments.

Accordingly, the invention further provides a method for executing the following steps:
penalizing a user whose acceptance history shows that the user is a cheater according to an outlier test,
prohibiting a user from accepting EV payment if the user's acceptance history shows that the user is a cheater according to an outlier test.

Further, the inventive method can provide steps for enabling sellers to shield payment offers from cheaters, according to outlier measures. For example, the inventive method can enable a seller to determine which users can accept the seller's offer according to an outlier measurement. For instance, the system can enable a seller to only make EV payments to recipients whose acceptance history shows that they buy from sellers in EVSPQ-RB 10% or more of the time.

Accordingly, the invention further provides a method for executing the following steps:
enabling a seller to set an outlier measurement threshold such that the seller's payment offer is shielded from any user whose acceptance history has an outlier/cheater measurement above that threshold,
shielding the seller's offer from any user whose outlier measurement is above the threshold set by the seller.

Note that, as disclosed in U.S. patent application Ser. No. 10/042,975, an acceptance can be of many kinds, depending on whether a sales message is delivered via a website ad, a telephone conversation, an online video, a meeting, and so forth. Thus, outlier tests can be performed on different kinds of acceptances, different kinds of sales messages, that is. Thus, the inventive method also provides for enabling a seller to set different shielding thresholds for different payment offers (i.e., for different kinds of payment acceptances).

Below, we describe four outlier test methods that the inventive method can include.

Outlier Test Recipient's History of Buying from a Seller After Being Exposed to the Seller's Message Via the EVSPQ-RB

For a seller who is paying a prospect for attention to a sales message, a key question is whether the prospect is sincerely interested in possibly buying from the seller—i.e., whether the prospect has already made up his mind where to buy from or not.

One way to “measure” the prospect's intention is to keep track of a user's purchases and calculate the percentage of times that a prospect buys from a seller after the prospect is exposed to a seller's message, provided that the prospect buys at all.

We define the term in/out purchase ratio as a ratio of measurements taken after a user has made a search in EVSPQ-RB for a product or service, and after the user has subsequently made a purchase matching the search. Given this scenario, the in/out purchase ratio is:
(the number purchases made from sellers that the user is exposed to via the EVSPQ-RB)/(the number purchases made from sellers that the user is not exposed to in his search)

Accordingly, the inventive method can include the following steps that the EVSPQ-RB executes when a recipient claims a payoff from an EV payment bet:
(1) asking the recipient whether he made the required purchase, and if so, who the seller was that he bought from, and/or asks the recipient if he bought from a seller whose sales message he was exposed to via the EVSPQ-RB or from a seller who has not posted an offer in the EVSPQ-RB,
(2) storing the recipient's response in the recipient's user history,
(3) measuring the in/out purchase ratio, the ratio of purchases from sellers in the EVSPQ and purchases from sellers without, as reported/claimed by the recipient.

The system may not have to ask the recipient if he bought from a seller whose offer is posted in the EVSPQ because the EVSPQ can include the step of checking the seller name that the recipient reports against the list of sellers in its database of seller, to determine whether the recipient bought from an EVSPQ-listed seller, in particular, from a seller who ad the recipient was exposed to.

The feedback-and-measurement process above keeps track of how frequently a buyer purchases from an EVSPQ-RB seller who message he has been exposed to, if he makes a purchase at all. That is, it roughly gives a “probability” that a realbuyer will buy from a seller whose sales message he is exposed to via EVSPQ-RB. We put the term probability in quotes because the measurement is actually just a measure of past behavior not a true probability.

Since a user's responses are key to creating a useful in/out purchase ratio, a two-bet payment process will be better than a one-bet payment process for gathering responses (see above).

We define the term in/out weighted purchase ratio as a ratio of measurements taken in the same situation, but where the amount of money spent in the purchase is measured as well. Given this scenario, the in/out weighted purchase ratio is:
(the amount of money spent with sellers that the user is exposed to via the EVSPQ-RB)/(the amount of money spent with sellers that the user is not exposed to via his search).

A variety of more specialized, subtle in/out purchase ratios can, and will, be conceived and employed in outlier tests that attempt to measure whether the recipient of EV payment is a free-rider or not.

The inventive method can further provide steps for enabling a seller to block a recipient from accepting or seeing the seller's payment offer depending on the in/out purchasing ratio in the recipient's acceptance and claim history.

Accordingly, the invention can provide the EVSPQ-RB to execute the following steps:
enabling a seller set a threshold level for an in/out purchasing ratio, such that recipient's who have a ratio below the threshold will not be permitted to accept the seller's payment offer(s),
when a user enters search criteria matching a seller's payment offer:
   checking the user's acceptance and claim history to see if the user's in/out purchasing ratio is below the seller's threshold,
   and if it is below the threshold, blocking the user from accepting the offer, or not showing the offer to the recipient.

The inventive method can, differently, enable a seller to automatically discount the amount of payment that he offers a user based upon the user's in/out purchasing ratio. For example, a user who has demonstrated a propensity to purchase 5% of the time from a seller whose sales message he has seen via EVSPQ-RB might be offered, say, 25% of the normal payment offered to other users.

Accordingly, the invention can provide the EVSPQ-RB to execute the following steps:
enabling a seller set a discount percentage that corresponds to an in/out purchasing ratio, such that recipient's who have a ratio below the threshold will be offered a payment that is discounted from a base payment offer by the discount percentage,
when a user enters search criteria matching a seller's payment offer:
   checking the user's acceptance and claim history to see if the user's in/out purchasing ratio is below the seller's threshold,
   and if it is below the threshold, discounting the payment amount in the offer by the discount amount set by the seller.

### Detecting and Rewarding High Probability Prospects

As described above, an EVSPQ-RB can include methods for enabling a seller to discount the amount of payment to a prospect based on statistics that measure the prospect's past behavior, for example, based on how often the prospect bought from advertisers that paid the prospect. These methods relied on creating statistics for detecting “cheaters” or low probability prospects.

The flip side of the ability to detect cheaters by statistical methods is the ability to detect higher quality prospects, as well—those prospects who are “the opposite” of cheaters, so to speak. In other words, a method that detects “cheaters” will usually detect the opposite.

Thus, an EVSPQ-RB can include algorithms and formulas for finding users who have a higher probability than average to purchase from an advertiser in a competitive pay-the-realbuyer directory.

In addition, the system can include steps and formulas for enabling an advertiser to offer to pay a bonus to searchers who demonstrate a higher probability of purchasing from advertisers whose messages they are exposed to. The system can enable an advertiser to set the bonus, or can set the bonus by a system formula that the advertiser accepts.

It is quite possible that an EVSPQ-RB will evolve so that prospects who demonstrate a higher propensity than average to buy from advertisers will be paid more, on a custom basis, than prospects who demonstrate a lower propensity.

This propensity can be measured by the kinds of cheat-detection methods, formulas and statistics described above, but also by other factors. In practice, such algorithms and formulas, like credit scoring formulas that attempt to predict the probability of default, will be complicated. However, they will usually use measurements of the frequency with which users buy from advertisers who they have received payment from in exchange for being exposed to the advertisers' messages.

### Outlier Test: “Greediness” of Acceptances

An EVSPQ-RB will present a list of offers under given search criteria, usually sorted in order of the amount of payment, highest to lowest, and so, a user will have a choice as to which offers to accept.

A prospect engaging in natural searching behavior will not accept payment offers solely based on the amount of EV payment they offer, such as the top three highest paying offers.

A cheater will try to maximize EV payment (although he but may also disguise his cheating by accepting less than the maximal payments that are offered).

So, another outlier test that the inventive method can include is a test that measures, per acceptance, how close the user is to the “greediest search” for the list that that user is exposed to. For instance, if the user is exposed to 10 payment offers and he accepts the top offer, then that is the greediest search. If he then accepts the second highest offer, then that, too, is the greediest search, because the user has already accepted the first highest offer.

The inventive method can measure the “greediness” of each acceptance and store this measurement along with an acceptance in the user's acceptance record.

The inventive method can further include steps for applying an outlier test to the greediness measurements to determine whether a user is an outlier in this respect.

The method can further provide steps for penalizing a user who is deemed an outlier according to such an outlier test.

### Outlier Test Time Spent Being Exposed to a Sales Message

If a recipient does not spend more than a threshold amount of time being exposed to a sales message, such as at a website, on a phone call, and viewing an online video—then he is not really an interested buyer.

Thus, the inventive method can include a process for measuring the amount of time that a user spends being exposed to a seller's message, per acceptance stored in the user's acceptance history, and further, for applying an outlier tests to these measurements to determine whether a user is an outlier in this respect.

The method can further provide steps for penalizing a user who is deemed an outlier according to such an outlier test.

Using Seller Reporting to Spot and Flag Users with Little or No Intention to Buy

A way to detect a cheater, that is different from outlier testing, is to enable sellers to report suspected cheaters to the system.

This method is especially useful where conversation advertising, such as a phone call, is used. For example, assume Reece accepts payment for a phone call to a tennis shop. And assume that the manager talks to Reece and feels that Reece is not sincerely interested in possibly buying from the shop because, let's say, Reece only stays on the phone for thirty seconds. The manager could then contact the system to report Reece as a potential cheater.

Accordingly, the invention can provide a method of:
enabling a seller to report that a payment recipient appears to be “gaming” or “free-riding” the system by having no intention of purchasing from the seller, for a specified payment,
storing the report, or a summary of the report, in the recipient's acceptance record (and hence, the recipient's acceptance history),
penalizing a recipient whose number of reports in his acceptance history exceeds a threshold.

The system can further enable a seller to void a payment if the seller feels that the recipient is a “cheater.” The ability to void a payment will depend on the meta-rules of the system.

### B1. Deterring the Sham Purchase Cheat

(Collusion: Backdating and/or Forgery of Receipts)

In this cheat, a user colludes with a seller, usually an offline seller, to forge or backdate a receipt. This problem is especially threatening with cash receipts and certain purchase orders that are not time-stamped and that can be forged.

A powerful method for stopping this cheat is to use a two-bet payment process in which a recipient must win two bets, a first bet, and then a second bet that uses the payoff from the first bet as the stake and EV of the second bet.

In this two-bet case, if a recipient wins a first-bet for an acceptance, the system:
asks the recipient of the winning acceptance to submit a payoff claim stating
   whether he bought, as required by the terms of the accepted offer,
   who the recipient bought from,
   some of the receipt data (thereby proving that a receipt exists for the purchase).

Thus, the recipient will have to state the seller who he bought from. If this seller is a colluding cheater, the seller and the recipient will only be able to succeed in this cheat if they also win the second stage bet.

If the recipient and seller do not win the second stage bet, they will not be able to do the cheat again, in most cases, because: (a) realbuyer payment offers may prohibit multiple acceptances based on purchasing from the same seller, and (b) the system can flag the fact that multiple payoff claims have been made by a recipient using the same seller.

In other words, a recipient would need to find many sellers to cheat with him in advance of ever receiving a second stage payoff, which is difficult.

If the recipient is not required to furnish some receipt data, then another cheating gambit is possible. A recipient can accept a very large number of offers; enough to win many first stage payoffs, and then make many (first bet) payoff claims, using different seller names for bogus sales. Then, if the recipient wins the second stage bet, the recipient can approach the corresponding seller (the seller that the recipient falsely claimed had sold him a product) and ask the seller to forge a receipt for a sale.

This gambit can be deterred by the system keeping statistics on how many first-bet payoff claims a user has made. An outlier number would indicate cheating. Hence the inventive method can include steps for flagging an outlier number of first-bet payoff claims by a recipient.

Further, outlier number of acceptance can indicate that a user is cheating. Hence the inventive method can include steps for flagging an outlier number of acceptances by a recipient.

Further, an outlier number of uses of a certain type of receipt, like a cash receipt, as a percentage of all types of receipts used, would also reveal this cheat. Hence the inventive method can include steps for flagging that an outlier number of a given type of receipt used by a recipient.

Note: another solution to the sham purchase cheat is to offer bonuses to buyers who report their purchases in advance of winning and EV payment bet. Such buyers cannot cost-effectively engage in the forgery cheat.

### B2. Deterring the Multiple Use of Same Receipt Cheat

Another cheat that arises by some users of an EVSPQ is the problem of more than one user claiming the same sale, by using the same receipt (proof-of-transaction).

For instance, assume Reece knows she is going to buy a pair of sunglasses. She tells her friends to search EVSPQ and accept payment offers from sunglasses sellers.

Then, she and her friends will have a set of acceptances—provisional, EV payments, that is. They simply see if one of those payments wins its bet, and if one wins, they use Reece's genuine receipt and claim it was for the winning acceptance, even though that winning acceptance is not Reece's acceptance.

To deter this cheat, the meta-rules of the system can require that a receipt be labeled in some way to identify the buyer, such as the name on a credit card receipt.

Another meta-rule can be that a family can only have one acceptance for a given sale, to stop the problem of having a receipt labeled with a family name.

If a receipt is unlabelled, the multiple-use-of-a-receipt problem remains.

Another way to deter this cheat for the system to include steps for tracking the number of times that two specified users have an acceptance in common for the same specified product. For example, if Reece and Reyna do accept the same offers a very high percentage of the time compared to an average, then this behavior is suspicious. The inventive method can provide taking two user's acceptance histories and performing and measuring the proportion of acceptances that they have in common. This proportion can then be compared to the average proportion, taking the acceptance histories of two “average” users as a comparison.

If the proportion of acceptances in common in two users acceptance histories is higher than a threshold, the system can flag the pair of users as potential cheater, and can restrict their privileges to use the system.

The system can include database-searching algorithms for correlating the acceptance histories of users and flagging unusual correlations of identical searches. This kind of correlation searching can be narrowed by choosing to correlate users who live in the same area, and are more likely to engage in the multiple-use-of-receipt cheat.

Cash receipts will be abused more than electronic receipts. U.S. application Ser. No. 10/042,975 disclosed how sellers could use a pricing mechanism to adjust for cheats using cash receipts. That is, recipients can be offered less if they provide proof-of-purchase that is a cash receipt rather than a labeled receipt, such as a credit-card receipt.

Thus, the system can enable a seller to vary the payment of an offer by whether the form of payment is labeled, and by how it is labeled. This method is equivalent, in the author's opinion, with the “payment vehicle condition” disclosed in application Ser. No. 10/042,975.

U.S. patent application Ser. No. 10/700,836 also described methods for deterring the multiple-use-of-receipt cheat, and those methods are incorporated by reference.

### B3. Deterring the Multiple Identities Cheat

One cheat a recipient can attempt is to register more than one user identity and accept a seller's offer using more than one identity—i.e., accept the same offer multiple times using different identities.

U.S. patent application Ser. No. 10/042,975 described user identification methods for deterring this cheat. U.S. patent application Ser. No. 10/700,836 elaborated on such methods.

I claim:

1. a method for improving the operation of an expected value system for paying and qualifying audiences (EVSPQ),
an EVSPQ being online database system for paying a user for his attention provided that he meets specified conditions, in particular, a condition that he buys a specified product after being exposed to a sales message,
using the system, a recipient of EV payment accepts a payment offer; the system stores this acceptance in a recipient's acceptance history, and triggers the execution of an EV payment bet corresponding to the terms of the payment offer,
if the recipient wins this payment bet, the EVSPQ enables the recipient to state whether he has met the conditions of the payment offer, and therefore, is owed the payment bet payoff,
the inventive method comprising the following steps:
when a recipient claims a payoff from an EV payment bet, the EVSPQ asking the recipient whether he made the required purchase from a seller who has posted an offer in the EVSPQ or from a seller who has not posted an offer in the EVSPQ,
the EVSQP storing the recipient's response in the recipient's user history,
the EVSPQ measuring the ratio of purchases from sellers in the EVSPQ and purchases from sellers without,
the EVSPQ enabling sellers to selectively shield offers from users whose ratio, or
equivalently useful statistic, is below a threshold.
